(19) United States
(12) Patent Application Publication
(10) Pub. No.: US 2011/0037347 A1
(43) Pub. Date: Feb. 17, 2011

(54) LINEAR DRIVE ULTRASONIC MOTOR

(75) Inventors: Hiroyuki TAKIZAWA, Tokyo (JP); Tetsuyuki SAKAMOTO, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/908,252

(22) Filed: Oct. 20, 2010

Related U.S. Application Data
(63) Continuation of application No. PCT/JP2009/057180, filed on Apr. 8, 2009.

(30) Foreign Application Priority Data
Apr. 24, 2008 (JP) 2008-114094

(51) Int. Cl. H02N 2/04

(52) U.S. Cl. 310/323.02

(57) ABSTRACT

There is provided a linear drive ultrasonic motor of a small size in which, it is possible to achieve a stable thrust, and in which, there are fewer constraints regarding a connection with an external apparatus.

The linear drive ultrasonic motor includes at least an ultrasonic vibrator having a piezoelectric element, a driven member which is driven by a frictional force between the driven member and the ultrasonic vibrator, a pressing member which presses the ultrasonic vibrator such that a frictional force is generated between the ultrasonic vibrator and the driven member, a first case member in which, a first accommodating recess is formed, and the ultrasonic vibrator and the pressing member are accommodated inside the first accommodating recess, a guiding means which movably supports the driven member, and a second case member in which, a second accommodating recess is formed, and the guiding means is accommodated inside the second accommodating recess.

### TECHNICAL FIELD

The present invention relates to a linear drive ultrasonic motor.

### BACKGROUND ART

As a conventional linear drive ultrasonic motor, a vibration apparatus described in Patent Literature 1 can be cited as an example (FIG. 3A and FIG. 3B). Here, FIG. 3A and FIG. 3B are diagrams showing a structure of a conventional linear drive ultrasonic motor, where, FIG. 3A is an exploded perspective view and FIG. 3B is a vertical cross-sectional view.

The vibration apparatus shown in FIG. 3A and FIG. 3B includes a case 906 which accommodates a vibrating body 901, a mobile object 904 which passes through the case 906 and makes a contact with the vibrating body 901, and a pressing spring 905 which generates thrust (bias) which brings the mobile object 904 and the vibrating body 901 in a pressurized contact. The pressing spring 905 is installed at an outer side of the case 906. An opening portion is formed in a side of the case 906, facing the vibrating body 901, and the thrust of the pressing spring 905 acts on the vibrating body 901 through the opening portion. In other words, this vibration apparatus has a structure in which the pressing spring 905 is installed on the outer side of the case 906 while covering the opening portion of the case 906, and a deformed portion (a flat surface portion covering the opening portion) of the pressing spring 905 which generates the thrust is exposed.

Patent Literature 1: Japanese Patent No. 3524248 Specification

### DISCLOSURE OF THE INVENTION

### Problems to be Solved by the Invention

However, in the vibration apparatus described in Patent Literature 1, in a case of installing on some external apparatus, for avoiding a change in the thrust of the pressing spring 905, there is a restriction of designing that the pressing spring 905 does not make a contact with a member of the external apparatus, in other words, that an arrangement is to be made to avoid the pressing spring 905.

The present invention has been made in view of the abovementioned circumstances, and an object of the present invention is to provide a small-size linear drive ultrasonic motor which is capable of achieving stable thrust, and which has fewer restrictions regarding a relationship with an external apparatus.

### Means for Solving the Problems

To solve the abovementioned problems and to achieve the object, a linear drive ultrasonic motor according to the present invention includes at least

an ultrasonic vibrator having a piezoelectric element,

a driven member which is driven by a frictional force between the driven member and the ultrasonic vibrator,

a pressing member which presses the ultrasonic vibrator such that a frictional force is generated between the ultrasonic vibrator and the driven member,

a first case member in which, a first accommodating recess is formed, and the ultrasonic vibrator and the pressing member are accommodated inside the first accommodating recess,

a guiding means which movably supports the driven member, and

a second case member in which, a second accommodating recess is formed, and the guiding means is accommodated inside the second accommodating recess.

In the linear drive ultrasonic motor according to the present invention, it is preferable that the first case member and the second case member are assembled together in a state of an edge surface of the first accommodating recess and an edge surface of the second accommodating recess in a mutual contact.

In the linear drive ultrasonic motor according to the present invention, it is preferable that an opening portion is formed by a first groove which is provided along a direction in which the driven member is driven, at the edge surface of the first accommodating recess and a second groove which is provided along a direction in which the driven member is driven, at an edge surface of the second accommodating recess, being disposed to be facing mutually, and that the driven member is extended outward of the first case member and the second case member upon passing through the opening portion.

### EFFECTS OF THE INVENTION

The linear drive ultrasonic motor according to the present invention is capable of achieving a stable pressing force, and there are fewer constraints regarding a connection with an external apparatus, and also a small-sizing is possible.

### BRIEF DESCRIPTION OF THE DRAWINGS

FIG. 1 is an exploded perspective view showing a structure of an ultrasonic motor according to an embodiment of the present invention;

FIG. 2 is a perspective view showing an appearance of the ultrasonic motor in an assembled state;

FIG. 3A is a diagram showing a structure of a conventional linear drive ultrasonic motor, and FIG. 3A is an exploded perspective view; and

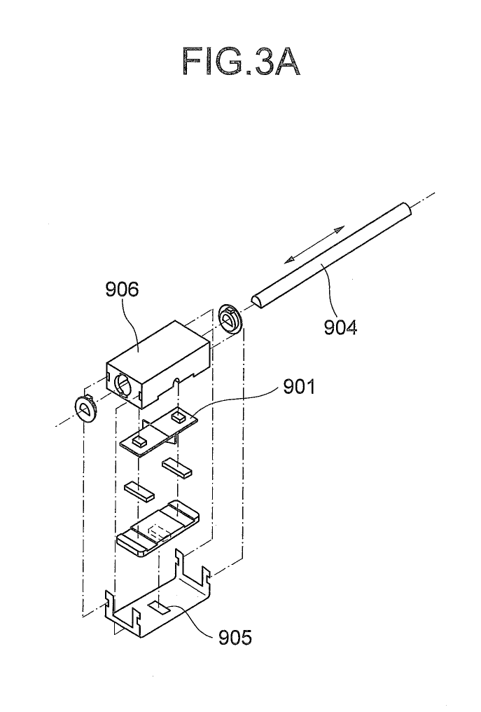

FIG. 3B is a diagram showing the structure of the conventional linear drive ultrasonic motor, and FIG. 3B is a vertical cross-sectional view.

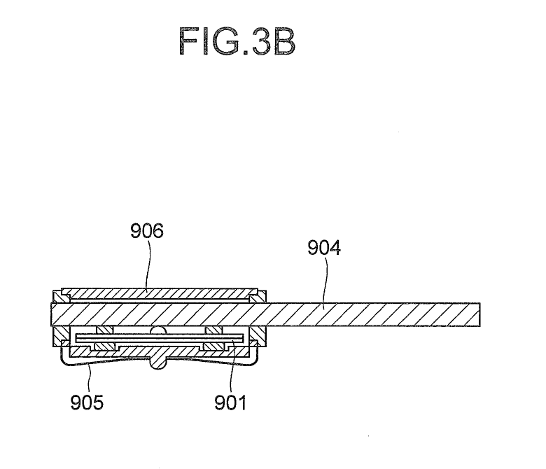

### DESCRIPTION OF REFERENCE NUMERALS

10 ultrasonic motor (linear drive ultrasonic motor)
10g opening portion
11 first case member
11g first groove
11h screw hole
11s edge surface
12 second case member
12g second groove
12h screw hole
16 first accommodating recess
18 second accommodating recess
21 pressing member
22 vibrator (ultrasonic vibrator)
22a stator
23 supporting member
24 driven member
24a flat surface portion
24b curved surface portion
25, 26, 27, 28 rolling members (guiding means)
29 guiding member
29a, 29b, 29c, 29d guide hole portions
31 connecting portion
36 pressing screw (pressurizing member)
37 case setscrew

### BEST MODE FOR CARRYING OUT THE INVENTION

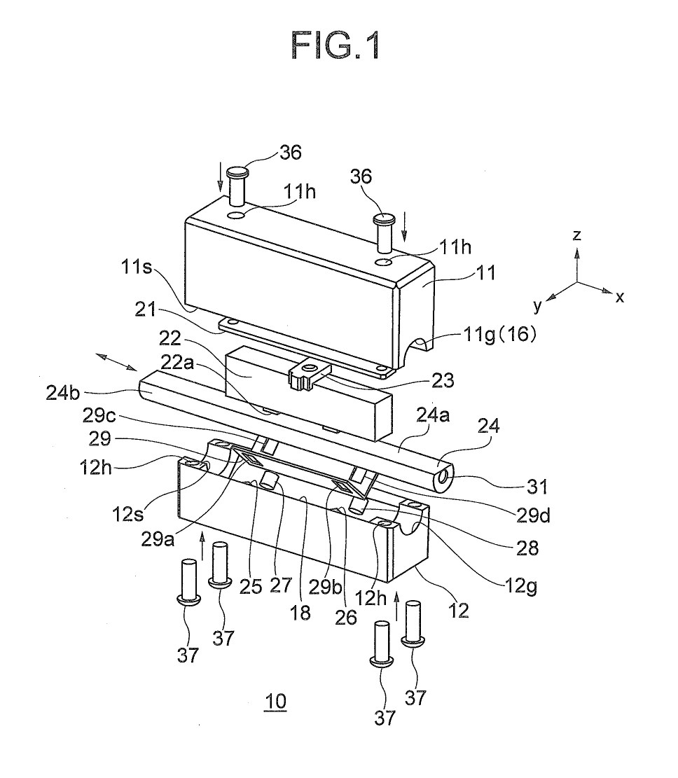

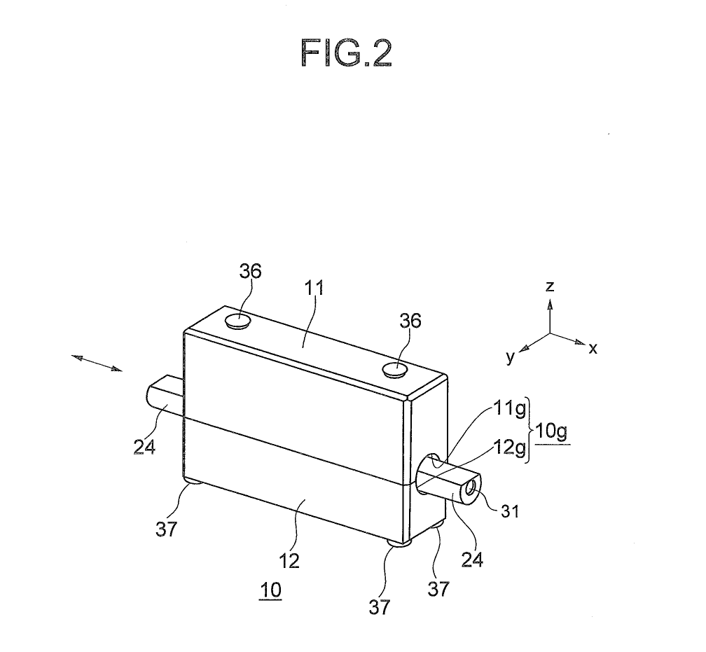

An ultrasonic motor 10 (linear drive ultrasonic motor) according to an embodiment of the present invention will be described below while referring to FIG. 1 and FIG. 2. However, the present invention is not restricted to the following embodiment. Here, FIG. 1 is an exploded perspective view showing a structure of the ultrasonic motor, and FIG. 2 is a perspective view showing an appearance of the ultrasonic motor in an assembled state.

As shown in FIG. 1, the ultrasonic motor 10 includes a vibrator 22 as an ultrasonic vibrator, a driven member 24, a pressing member 21, a first case member 11, rolling members 25, 26, 27, and 28 as a guiding means, and a second case member 12.

Each member will be described below in detail.

Each of the vibrator 22, the first case member 11, and the second case member 12 has a substantially rectangular parallelepiped outer shape. A first accommodating recess 16 is formed at an interior of the first case member 11, and a second accommodating recess 18 is formed at an interior of the case member 12.

The vibrator 22 and the pressing member 21 are accommodated in order from a side of an opening (a side of an edge surface 11s) in a direction of height of the ultrasonic, motor 10 (z-direction in FIG. 1), inside the first accommodating recess 16. The pressing member 21 is a plate spring in the form of a long plate, and is disposed such that a longitudinal direction thereof is along a longitudinal direction (x-direction in FIG. 1) of the ultrasonic motor 10 and the first case member 11.

On the other hand, a guiding member 29 and the rolling members 25, 26, 27, and 28 are accommodated in order from a side of an opening (a side of an edge surface 12s) in the direction of height of the ultrasonic motor 10, inside the second accommodating recess 18. The rolling members 25, 26, 27, and 28 are arranged to be in two rows of two each along a longitudinal direction of the second case member 12.

The guiding member 29 has a shape of a long-plate member bent with a direction of width as a center. This guiding member 29 includes guide hole portions 29a, 29b, 29c, and 29d which are through holes, at positions corresponding to the rolling members 25, 26, 27, and 28 respectively when accommodated inside the second accommodating recess 18 such that a bent portion is accommodated inside the second case member 12. It is preferable that a position of the guiding member 29 is fixed by engaging with an engaging portion (not shown in the diagram) provided inside the second accommodating recess 18. According to this structure, in the second accommodating recess 18 of the case member 12, the four rolling members 25, 26, 27, and 28 are rollingly positioned by being inserted from a lower side and an upper side of the guide hole portions 29a, 29b, 29c, and 29d respectively of the guiding member 29.

The driven member 24 is a member in the form of a shaft having a D-shaped cross-section. When the first case member 11 and the second case member 12 are assembled together, a flat surface portion 24a makes a contact with the vibrator 22 via a stator 22a, and a curved surface portion 24b makes a contact with the rolling member 25.

The first case member 11 and the second case member 12 are assembled together in a state of the edge surface 11s of the first accommodating recess 16 and an edge surface 12s of the second accommodating recess 18 in a mutual contact. This assembling is carried out by screwing a case setscrew 37 through a screw hole 12h provided in the second case member 12.

A first groove 11g is formed in the edge surface 11s of the first accommodating recess 16, along a direction in which the driven member 24 is driven (x-direction). On the other hand, a second groove 12g is formed in the second edge surface 12s of the second accommodating recess 18, to correspond with the first groove 11g when the first case member 11 and the second case member 12 are assembled together. An opening portion 10g is formed by the first groove 11g and the second groove 12g being disposed to be facing mutually after assembling. The driven member 24 is extended outward from the first case member 11 and the second case member 12 upon passing through the opening portion 10g.

On the other hand, inside the first case member 11 and the second case member 12, the driven member 24 is supported by making a contact with the rolling members 25, 26, 27, and 28 which are protruded toward an upper side of the guide hole portions 29a, 29b, 29c, and 29d of the guiding member 29. The driven member 24, by being supported by the rolling members 25, 26, 27, and 28 which are disposed along the longitudinal direction of the second case member 12, is movable in the longitudinal direction of the case member 12, or in other words, in a longitudinal direction of the driven member 24.

An upper surface of both end portions in a longitudinal direction of the pressing member 21 can be pressed by a pressing screw 36 (pressurizing member). A front tip of the pressing screw 36 is extended inside the first accommodating recess 16, through a screws hole 11h which is a through hole provided in an upper surface of the first case member 11. Moreover, the pressing member 21 is disposed such that a lower surface of a central portion in a longitudinal direction makes a contact with a supporting member 23 for positioning of the vibrator 22. Here, the supporting member 23 is fixed to a center in a longitudinal direction (x-direction in FIG. 1) of the vibrator 22. Moreover, the vibrator 22 is formed by an ultrasonic vibrator (such as a piezoelectric element). A method of driving of the ultrasonic vibrator being known, an electrical wiring for driving the vibrator 22 is omitted in the following diagram. Moreover, an engaging groove (not shown in the diagram) with which, a projected portion of the supporting member 23 is engaged is formed inside the first accommodating recess 16 of the first case member 11.

As shown in FIG. 1 and FIG. 2, both end portions of the driven member 24 are provided with a connecting portion 31 for connecting an external apparatus (not shown in the diagram), and it is possible to realize a linear movable apparatus.

Assembling of the ultrasonic motor 10 having the abovementioned structure is carried out as follows.

Firstly, the pressing member 21 is put inside the first accommodating recess 16 of the first case member 11. Next, the vibrator 22 is fixed to the first case member 11 by fitting the projected portion of the supporting member 23 and the engaging portion of the first case member 11. Since the projecting portion of the supporting member 23 and the engaging portion of the first case member 11 are fitted, handling is possible integrally in this state.

Next, inside the second accommodating recess 18, the first case member 11 and the second case member 12 are assembled together by the case setscrew 37 from a side of the case member 12 in a state of the driven member 24 supported by the rolling members 25, 26, 27, and 28. Furthermore, after assembling, a thrust by the pressing member 21 is set to a desired value by adjusting an amount of the pressing screw 36 extending into the first accommodating recess 16. After setting the thrust, the pressing screw 36 can also be fixed by sticking to the screw hole 11h of the first case member 11. The adjustment of the thrust can also be carried out by changing a material and a shape of the pressing member 21.

The first case member 11 has a hardness sufficiently higher than the pressing member 21, and even when the first case member 11 makes a contact with a member of an external apparatus which is not shown in the diagram, an amount of bending of the pressing member 21 does not change. Therefore, a degree of freedom of designing the external apparatus improves. Moreover, since the pressing member 21 is not exposed to an outside of the first case member 11, an outer shape of the first case member 11 can be used for positioning upon bringing in contact with the external apparatus. Furthermore, it is also possible to install directly on the external apparatus by providing an installing hole in the first case member 11.

When the driven member is movable, as the guiding means, it is also possible to adopt an arrangement such as providing a hemispherical member which does not roll, or in the second case member, providing a hemispherical protruding portion to a portion which is in contact with the driven member, or letting a portion of contact to be a smooth surface.

In the abovementioned arrangement, since a frictional force is generated between the vibrator 22 and the driven member 24 by the pressing member 21 pressing the vibrator 22 against the driven member 24, the driven member 24 moves in a longitudinal direction thereof due to the vibrations of the vibrator 22. Furthermore, since the driven member 24 moves while being supported by the rolling members 25, 26, 27, and 28, it is possible to achieve a stable thrust.

Since it is possible to fix the first case member 11 to the external apparatus, it is possible to apply to a wide-range linear movable apparatus while achieving stably the thrust by the pressing member 21.

Normally, in an ultrasonic motor apparatus, letting the structure to be a unit structure in which main components are packaged is effective from points of a generality and stabilizing of characters, and small-sizing has been sought. Whereas, in a conventional ultrasonic motor, in small-sizing in a state of a pressing member (biasing member) capsuled in a case member, a variation in the thrust is susceptible to be substantial, thereby making it difficult. However, a function of protecting the contents therein as a case in a state of the pressing member being installed on the case and exposed is insufficient.

Whereas, according to the ultrasonic motor according to the embodiment described above, the positioning of the pressing member can be carried out easily, and a unit structure of which, assembling and maintenance are easy, can be realized. In other words, the vibrator 22 is accommodated upon guiding toward the opening portion of the first case member 11 having a box-shape, and the pressing member 21 is accommodated upon guiding toward an opposite side of the opening portion of the first case member 11. Accordingly, the small-sizing become possible and also, since the first case member 11 which is a hard body protects by covering each member including the pressing member 21, it is possible to fix the first case member 11 to the external apparatus and to bring in contact with the external apparatus for positioning. This is similarly applicable to the case member 12.

Furthermore, since the vibrator 22 makes a contact with the driven member 24 by the thrust of the pressing member 21 inside a space closed by the second case member 12, it is possible to prevent generation of abnormal noise. Moreover, by regulating a position of any one of or both the pressing member 21 and the vibrator 22, it is possible to suppress a generation of resonance which is unnecessary for a precision driving of the driven member 24. Furthermore, by an arrangement of disposing the vibrator 22 between the pressing member 21 and the driven member 24, a movement of the driven member 24 becomes smooth.

Moreover, since the ultrasonic motor 10 includes two case members namely the first case member 11 and the second case member 12, work at the time of assembling and maintenance becomes easy.

### INDUSTRIAL APPLICABILITY

As it has been described above, the linear drive motor according to the present invention is suitable for a highly accurate drive of a small-size equipment.

1. A linear drive ultrasonic motor comprising at least:
an ultrasonic vibrator having a piezoelectric element;
a driven member which is driven by a frictional force between the driven member and the ultrasonic vibrator;
a pressing member which presses the ultrasonic vibrator such that a frictional force is generated between the ultrasonic vibrator and the driven member;
a first case member in which, a first accommodating recess is formed, and the ultrasonic vibrator and the pressing member are accommodated inside the first accommodating recess;
a guiding means which movably supports the driven member; and
a second case member in which, a second accommodating recess is formed, and the guiding means is accommodated inside the second accommodating recess.

2. The linear drive ultrasonic motor according to claim 1, wherein the first case member and the second case member are assembled together in a state of an edge surface of the first accommodating recess and an edge surface of the second accommodating recess in a mutual contact.

3. The linear drive ultrasonic motor according to claim 2, wherein
an opening portion is formed by a first groove which is provided along a direction in which the driven member is driven, at the edge surface of the first accommodating recess and a second groove which is provided along a direction in which the driven member is driven, at an edge surface of the second accommodating recess being disposed to be facing mutually, and
the driven member is extended outward of the first case member and the second case member upon passing through the opening portion.
